(19) United States
(12) Patent Application Publication
(10) Pub. No.: US 2016/0045986 A1
(43) Pub. Date: Feb. 18, 2016

(54) ALUMINUM-FREE MAGNESIUM ALLOY

(71) Applicant: Ulrich BRUHNKE, Ehningen (DE)

(72) Inventors: Ulrich BRUHNKE, Ehningen (DE); Ralf ANDERSECK, Rudelzhausen (DE); Karl-Heinz LINDNER, Muelheim (DE)

(21) Appl. No.: 14/783,551

(22) PCT Filed: Apr. 4, 2014
(86) PCT No.: PCT/DE2014/000180

§ 371 Date: Oct. 9, 2015

(30) Foreign Application Priority Data
Apr. 10, 2013 (DE) 10 203 006 170.9

(51) Int. Cl. B23K 35/28; B23K 35/02; C22C 23/00; C22C 23/06

(52) U.S. Cl. CPC B23K 35/284; C22C 23/06; B23K 35/0261; C22C 23/00

(57) ABSTRACT

The aluminum-free magnesium alloy consists of a composition comprising 1.4 to 2.2 wt. % manganese, 0.4 to 4.0 cerium, 0.2 to 2.0 wt. % anthanum, 0.001 to 5 wt. % scandium, and magnesium as well as manufacturing-related impurities accounting for the remaining content in the alloy that is missing to make up 100 wt. %, and the ratio of cerium to lanthanum being 2:1.

The invention relates to an aluminum-free magnesium alloy and to the use for producing extruded, continuously cast or diecast semi-finished products or components and metal sheets.

Magnesium alloys are lightweight construction materials that, compared to the alloys of other metals, have a very low weight and are used where a low weight plays an important role, in particular in automotive engineering, in engine construction, and in aerospace engineering.

Offering very good strength properties and low specific weight, magnesium alloys are of great interest as metallic construction materials most notably for vehicle and aircraft construction.

A reduction in weight is needed especially in vehicle construction since additional elements are being installed, due to rising comfort and safety standards. Lightweight construction is also important for the design of energy-saving vehicles, in terms of processing magnesium materials, methods involving primary shaping by way of diecasting and metal forming by way of extrusion, forging, rolling, stretch forming or deep drawing are gaining importance. These methods allow lightweight components to be produced, for which demand is growing especially in vehicle construction.

Alloys having advantageous mechanical properties, and more particularly having high tensile strength, are included in the related art.

A magnesium alloy is known from DE 806 055 which by a composition of 0.5 to 10% metals from the group of rare earths, the remainder being magnesium, with the proviso that the rare earths comprise at least 50%, and more preferably at least 75%, neodymium, and no more than 25% lanthanum and cerium, separately or together, and praseodymium, and small amounts of samarium and traces of the elements of the yttrium group as the remainder, to which is added one or more of the following elements: manganese, aluminum, calcium, thorium, mercury, beryllium, zinc, cadmium and zirconium.

A magnesium alloy containing 2 to 8% rare earth metals is known from DE 42 08 504 A1, wherein the rare earth metal consists of samarium.

Further known magnesium alloys having advantageous mechanical properties comprise alloys containing zinc and mixtures of rare earth metals that have a high content of cerium. Such an alloy contains approximately 4.5 wt. % zinc, and approximately 1.0 wt. % rare earths having a high content of cerium. These alloys can achieve good mechanical properties but they are difficult to cast, making it difficult to cast parts of satisfactory quality. Welding may meet with difficulty if complicated assembled parts are involved.

Alloys having improved castability can be obtained by adding higher amounts of zinc and rare earths. However, these tend to be brittle. This can be prevented by way of a hydrogenating treatment, which in turn makes production more expensive.

Magnesium alloys having higher contents of other metal components, such as aluminum and zinc, which solidify with a fine-grained structure, have considerably worse corrosion properties than pure magnesium or magnesium-manganese alloys.

A silicon-containing, corrosion-resistant magnesium alloy having a fine-grained solidification structure is known from DE 1 433 108 A1. Manganese, zinc, and titanium are added to the magnesium alloy, in addition to silicon, and aluminum, cadmium and silver are added as further alloying components.

Additionally alloys containing manganese as well as further elements such as aluminum, copper, iron, nickel, calcium and the like, in addition to magnesium as the main component, are known from DE 199 15 278 A1, DE 198 38 784 A1, DE 679 158, DE 897 04 301 T2, and DE 44 46 898 A1, for example.

The known magnesium alloys have a wide variety of drawbacks.

U.S. Pat. No. 6,544,357 discloses a magnesium and aluminum alloy containing 0.1 or 0.2 wt. % up to 30 or 40 wt. % La, Ce, Pr, Nd, Sm, Tt, V, Cr, Mu, Zr, Nb, Mo, Hf, Ta, W, At, Ga, Si, B, Be, Ge, and Sb, along with other elements. The range of alloys that could potentially be produced here is so broad and unmanageable that it is impossible for a person skilled in the art to arrive at the alloy that is claimed hereinafter.

The presence of calcium can cause hot cracking after casting in a casting process that has a high cooling rate, such as in injection molding. In alloys containing magnesium-aluminum-zinc-manganese or magnesium-aluminum-manganese, the strength is reduced at higher temperatures.

The overall metal forming behavior, weldability, or corrosion resistance is degraded.

The cold workability of the most common magnesium alloys is limited due to the hexagonal crystal structure and low ductility. The majority of magnesium alloys exhibit brittle behavior at room temperature. In addition to high tensile strength, a ductile behavior is needed for certain metal forming processes to produce semi-finished products from magnesium alloys. Higher ductility allows improved metal forming and deformation behavior, as well as greater strength and toughness.

Many of the known magnesium alloys have drastically varying properties in the produced state.

It is the object of the invention to develop a magnesium alloy that is suitable for producing metal sheets, welding wire, profiled extruded and/or diecast sections or components, which is to say, that has good deformation properties, high corrosion resistance, improved weldabliity, a high yield strength, and good cold workability.

According to the invention, this is achieved by a magnesium alloy having the following composition:
manganese 1.4 to 2.2
cerium 0.4 to 4.0
lanthanum 0.2 to 2.0
scandium 0.0001 to 5

wherein the amounts are based on weight percent (wt. %) in the alloy, and magnesium and manufacturing-related impurities account for the remaining content in the alloy that is missing to make up 100% by weight, and the ratio of cerium to lanthanum is 2:1.

The magnesium alloy has a yield strength (Rp 0.2) of at least 120 Mpa, good strength properties over an extended temperature range, and high creep resistance, with adequate deformability.

The magnesium alloy according to the invention can be used to produce metal sheets, semi-finished products, or extruded and/or diecast components and profiled sections, as well as to produce welding wires. These can then be used to produce specific parts, preferably for use in vehicle construction, train construction, shipbuilding and aircraft construction, such as seat, window or door frames, automotive body shells, housings, carriers, mountings, supports and other small components.

A particularly advantageous composition of the magnesium alloy according to the invention is obtained when the same is produced from the following components: 97.15 wt. % aluminum-free magnesium, 1.8 wt. % manganese, 0.8 wt. % cerium, 0.3 wt. % lanthanum, and 0.15 wt. % scandium.

The alloy having this composition is characterized by good corrosion resistance, an improved cold working behavior, a lower warm creep behavior, and high yield strength. The addition of scandium results in structure-stabilizing and grain size-refining effects.

This magnesium alloy can be used in particular to produce metal sheets, profiled extruded and/or diecast sections and components, and for drawn welding wires.

1. An aluminum-free magnesium alloy, having the following composition:
manganese 1.4 to 2.2
cerium 0.4 to 4.0
lanthanum 0.2 to 2.0
scandium 0.0001 to 5
wherein the amounts are based on weight percent in the alloy, and magnesium and manufacturing-related impurities account for the remaining content in the alloy to make up 100% by weight, and the ratio of cerium to lanthanum is 2:1.

2. The aluminum-free magnesium alloy according to claim 1 in the form of profiled extruded or diecast sections.

3. The aluminum-free magnesium alloy according to claim 1 in the form of drawn welding wires.
